(19) United States
(12) Patent Application Publication
(10) Pub. No.: US 2016/0153106 A1
(43) Pub. Date: Jun. 2, 2016

(54) METHOD FOR PRODUCING A METAL UNDERCOAT MADE FROM PLATINUM ON A METAL SUBSTRATE

(71) Applicant: SNECMA, Paris (FR)

(72) Inventors: Juliette HUGOT, Jaunay-Clan (FR); Herve MOLET, La Celle Saint Avant (FR)

(73) Assignee: SNECMA, Paris (FR)

(21) Appl. No.: 14/905,173

(22) PCT Filed: Jul. 11, 2014
(86) PCT No.: PCT/FR2014/051795

§ 371 Date: Jan. 14, 2016

(30) Foreign Application Priority Data
Jul. 16, 2013 (FR) 1357003

(51) Int. Cl. C25D 5/10; F02C 3/14; C25D 3/50; C25D 5/50; C25D 3/66; C25D 3/44

(52) U.S. Cl. CPC C25D 5/10; C25D 3/665; C25D 3/44; C25D 3/50; C25D 5/50; F02C 3/14

(57) ABSTRACT

A method is for producing a metal undercoat made from platinum on a metallic substrate. The method includes providing a metallic part forming a substrate, providing an electrolyte bath formed from an ionic liquid medium with one or more aluminium salts, depositing a first layer of a first metal on the substrate so as to obtain a substrate coated with the first metallic layer, depositing a second layer of a second metal on the first layer so as to obtain a substrate coated with the first metallic layer and the second metallic layer. One of the first metal and the second metal is a metal of the platinum group (platinoid) and the other from the first metal and the second metal is aluminium deposited by electroplating with the electrolyte bath formed from an ionic liquid medium.

The invention relates to a method for producing a metallic undercoat based on platinoid on a metallic substrate, and a thermomechanical part fitted with such a metallic undercoat and a turbine engine comprising such a part.

Hereinbelow platinoid, or metal of the platinum group, means platinum, palladium, iridium, osmium, rhodium or ruthenium.

Such metallic undercoats belong in particular to a thermal barrier coating on a substrate made of a metallic part for resisting strong mechanical and thermal stresses in operation, in particular a substrate made of superalloy.

Such a thermomechanical part constitutes especially an aviation or terrestrial turbine engine part. By way of example said part can constitute a blade or a nozzle guide vane in the turbine engine and especially in a high-pressure turbine of an airplane turbojet or turboprop.

The search for increased efficiency of turbine engines, in particular in the field of aeronautics, and also for reducing fuel consumption and polluting emissions of gas and unburnt fuel have led to fuel combustion being performed closer to stoichiometric conditions. That situation is accompanied by an increase in the temperature of the gas leaving the combustion chamber and going to the turbine.

At present, the limiting temperature for use of superalloys is about 1100° C., while the temperature of the gas at the outlet from the combustion chamber or at the inlet of the turbine may be as high as 1600° C.

Consequently, it has been necessary to adapt the materials of the turbine to this increase in temperature, by improving techniques for cooling turbine blades (hollow blades) and/or by improving the properties of those materials for withstanding high temperatures. This second technique, used in combination with superalloys based on nickel and/or cobalt, has led to several solutions, including solutions involving depositing a thermally insulating coating on the superalloy substrate, which coating is known as a “thermal barrier” and is made up of a plurality of layers.

The use of thermal barriers in aeroengines has become widespread over the last thirty years, and it enables the temperature of the gas at the inlet to the turbines to be increased, the stream of cooling air to be reduced, and thus the efficiency of engines to be improved.

Specifically, the insulating coating serves to establish a temperature gradient through the coating on a cooled part under steady operating conditions that has a total amplitude that may exceed 100° C. for a coating having a thickness of around 150 to 200 μm and that presents conductivity of 1.1 W·m⁻¹·K⁻¹. The operating temperature of the underlying metal forming the substrate for the coating is thus decreased by the same gradient, thereby giving rise to considerable savings in the volume of cooling air that is needed and to considerable increases both in the lifetime of the part and also in the specific consumption of the turbine engine.

It is known to have recourse to a thermal barrier comprising a layer of ceramic based on zirconia stabilized with yttrium oxide, i.e. yttria-stabilized zirconia having a molar content of yttrium oxide between 4% and 12% (especially between 6 and 8%), and that presents a coefficient of expansion that is different from that of the superalloy constituting the substrate, with thermal conductivity that is quite low.

Among the coatings used, mention may be made of the fairly widespread use of a layer of ceramic based on zirconia that is partially stabilized with yttrium oxide, e.g. Zr_{0.92}Y_{0.08}O_{1.96}.

In order to anchor this ceramic layer, a metal undercoat having a coefficient of expansion that ideally is close to that of the substrate is generally interposed between the substrate of the part and the ceramic layer. In this way, the metal undercoat serves firstly to reduce the stress due to the difference between the coefficients of thermal expansion of the ceramic layer and of the substrate-forming superalloy.

This undercoat also provides adhesion between the substrate of the part and the ceramic layer, it being understood that adhesion between the undercoat and the substrate of the part takes place by interdiffusion, and adhesion between the undercoat and the ceramic layer takes place by mechanical anchoring and by the propensity of the undercoat to develop a thin oxide layer at high temperature at the ceramic/undercoat interface, which oxide layer provides chemical contact with the ceramic.

In addition, the metallic undercoat provides the superalloy of the part with protection against corrosion and oxidation phenomena (the ceramic layer is permeable to oxygen).

Specifically, it is known to use an undercoat constituted by nickel aluminide including a metal selected from platinum, chromium, palladium, ruthenium, iridium, osmium, rhodium, or a mixture of those metals, and/or a reactive element selected from zirconium (Zr), cerium (Ce), lanthanum (La), titanium (Ti), tantalum (Ta), hafnium (Hf), silicon (Si), and yttrium (Y).

For example, a coating of type Ni Pt Al is used, in which the platinum is inserted into the nickel lattice. The platinum is electrolytically deposited prior to the thermochemical aluminization treatment.

Likewise, a coating of type (Ni,Pt)Al is used in which the platinum is inserted into the lattice of the nickel of the β-NiAl intermetallic compounds.

When preparing thermal barriers, platinum performs two functions: it acts as a diffusion barrier to prevent interdiffusion of aluminium from the layer to the substrate. Furthermore, platinum aluminide increases the resistance to corrosion at high temperature and the adhesion of protective layers. However, platinum aluminide coatings degrade quickly at 1100° C.: there exist phase transformations associated with interdiffusion of the elements of the coating and of the substrate.

Under such circumstances, the metallic undercoat may be constituted by a platinum modified nickel aluminide NiPtAl using a method that comprises the following steps: preparing the surface of the part by chemical cleaning and sand-blasting; electrolytically plating a coating of platinum (Pt) on the part; optionally heat-treating the result in order to cause Pt to diffuse into the part; depositing aluminium (Al) using chemical vapor deposition (CVD) or physical vapor deposition (PVD); optionally heat-treating the result to cause Pt and Al to diffuse into the part; preparing the surface of the metallic undercoat as formed in this way; and depositing a ceramic coating using electron beam physical vapor deposition (EB-PVD).

Platinum is thus electrolytically deposited before the thermochemical treatment of vapor phase aluminization.

It should be recalled that electroplating serves to reduce onto a conductive part (the cathode) a metallic complex initially present in the solution by causing an electric current to flow from an anode (an electrode where an oxidation reaction takes place) to a cathode onto which deposition takes place (and at which other reduction reactions may take place simultaneously).

Solutions of various compositions are commercially available for platinum plating. The pH of such solutions may be basic, acidic, or neutral.

In plating solutions there are different compositions commercially available. The pH of these solutions can be basic, acid or neutral.

Compounds obtained at the end of platinum extraction are ammonium hexachloroplatinate (IV): (NH₄)2PtCl₆ or potassium hexachloroplatinate (IV): K₂PtCl₆. The main compounds of platinum present in platinum plating baths are derived from transforming those compounds.

Traditionally, the metallic undercoat comprises an alloy capable of forming a layer of protective alumina by oxidation: in particular, the use of a metallic undercoat comprising aluminium engenders by natural oxidation in air a layer of alumina Al₂O₃ which covers the entire undercoat.

Usually, the layer of ceramic is deposited on the part to be coated either by a projection technique (in particular plasma projection) or physical vapor deposition, that is, by evaporation (for example by EB-PVD or “Electron Beam Physical Vapor Deposition” forming a coating deposited in an evaporation container under vacuum under electron bombardment).

Conventionally, these thermal barriers therefore create discontinuity of thermal conductivity between the outer coating of the mechanical part, forming this thermal barrier, and the substrate of this coating forming the material constituting the part.

This results in parts with long shelf lives with thermal fatigue at high temperature.

It is understood that these current techniques are complex, costly and time-consuming due to the multiplicity of different methods involved, specifically generally electrolyte deposition of platinum, vapor phase aluminization and physical deposition of yttria-stabilized zirconia.

The aim therefore is to simplify the method for producing thermal barrier systems.

There have been attempts especially to produce a multi-element target (Pt, Al, Ni . . . ) likely to deposit in a single step a metallic undercoat NiPtAl of prime gamma-gamma type. But this research has yet to find a viable solution.

The aim of the present invention is to provide a method for overcoming the disadvantages of the prior art and in particular offering the possibility of simplifying the method for producing a thermal barrier system, and in particular the method for producing the metallic undercoat of a thermal barrier system.

To this end, according to the present invention the method is characterized in that it includes the following steps:
a) providing a metallic part forming a substrate,
b) providing an electrolyte bath formed from an ionic liquid medium with one or more aluminium salts,
c) depositing a first layer of a first metal on the substrate so as to obtain a substrate coated with the first metallic layer,
d) depositing a second layer of a second metal on the first layer so as to obtain a substrate coated with the first metallic layer and the second metallic layer,
wherein one of the first metal and the second metal is a metal of the platinum group (platinoid) and the other from the first metal and the second metal is aluminium deposited by electroplating with said electrolyte bath formed from an ionic liquid medium.

In this way, it is understood that because aluminium is deposited by liquid on a coated substrate of metal of the platinum group or else on the raw substrate, the method for producing the metallic undercoat is made easier relative to the techniques of the prior art performing chemical vapor deposition (CVD) or physical vapor deposition (PVD) of aluminium.

An electrolyte bath formed from an ionic liquid medium, known as bath of “molten salts” type is interesting since it allows simplified industrial practice.

Overall, by way of the solution according to the present invention it is possible to reduce manufacturing time and the costs associated with manufacturing of the thermal barrier.

The method preferably further comprises a heat treatment step of diffusion of the coated substrate, said diffusion heat treatment step being applied on the substrate coated with the first metallic layer and/or on the substrate coated with the first metallic layer of the second metallic layer.

Therefore, this diffusion heat treatment step is applied either between the deposition of the first metallic layer and the deposition of the second metallic layer or after deposition of the second metallic layer, or both between the deposition of the first metallic layer and deposition of the second metallic layer and after deposition of the second metallic layer.

According to the invention such a heat treatment step produces four embodiments as per the invention.

According to a first embodiment the following steps are conducted in order:
a) Depositing on the substrate, preferably electrolytically, a layer of a metal of the platinum group,
b) Depositing on the metallic layer of the platinum group, an aluminium layer electrolytically in ionic medium, and
c) Diffusion heat treatment.

According to a second embodiment the following steps are conducted in order:
a) Depositing on the substrate, preferably electrolytically, a layer of a metal of the platinum group,
b) Diffusion heat treatment,
c) Depositing on the metallic layer of the platinum group, an aluminium layer electrolytically in ionic medium, and
d) Diffusion heat treatment.

According to a third embodiment, the following steps are conducted in order:
a) Depositing on the substrate an aluminium layer electrolytically in ionic medium,
b) Depositing on the aluminium layer, preferably electrolytically, a layer of a metal of the platinum group, and
c) Diffusion heat treatment.

According to a fourth embodiment, the following steps are conducted in order:
a) Depositing on the substrate an aluminium layer electrolytically in ionic medium,
b) Diffusion heat treatment,
c) Depositing on the aluminium layer, preferably electrolytically, a layer of a metal of the platinum group, and
d) Diffusion heat treatment.

Advantageously, said metallic substrate is made of superalloy.

Said metallic substrate is preferably made of superalloy based on nickel. Alternatively said metallic substrate is made of superalloy based on cobalt.

In some preferred variant embodiments, during the deposition step of the platinoid layer, the following sub-steps are performed:

providing an ionic liquid medium or water-based electrolyte bath comprising a metal of the platinum group in solution, and

performing the electroplating of a layer of said metal of the platinum group with said electrolyte bath so as to obtain said coated substrate.

Forming the metallic layer, specifically the platinoid, by an electrochemical method, in this case electrolysis, combines two successive depositions by similar techniques (liquid and more precisely electrochemical method). This situation more easily manages the range of production especially in terms of handling and similar environment, but also with equipment of the same type, and the possibility of simplifying maintenance and use of workstations by the fact that necessary competencies for operators to control the whole method for producing the thermal barrier are reduced.

In this case therefore there is no control by the operator between the deposition steps of the first metallic layer and the second metallic layer; fewer masking steps of the part are conducted as identical masking can be used since it is a method of the same type (liquid) for depositing a multilayer coating and the same tooling may be used and treatment may be via unitary flow.

According to preferred embodiments the aluminium layer has a thickness between 10 and 50 μm, and preferably between 15 and 25 μm.

According to a preferred arrangement, said ionic liquid medium forming said electrolyte bath comprises by way of cation one from 1-ethyl-3-methylimidazolium (EMI), 1-butyl-1-methylpyrrolidinium (BMP) and 1-propyl-1-methylpyrrolidinium (PMP).

According to another preferred arrangement, said ionic liquid medium forming said electrolyte bath comprises by way of anion one from chlorine (Cl), bis(trifluoromethanesulfonyl)imide (NTF₂ or TFSI) and bis(fluorosulfonyl)imide (NF₂ or FSI).

Likewise, according to a preferred arrangement said ionic liquid medium forming said electrolyte bath comprises by way of aluminium salt aluminium trichloride (AlCl₃) and/or aluminium Bis(trifluoromethanesulfonyl)imide Al(III)NTf₂).

The present invention also relates to a thermomechanical part with a metallic undercoat based on platinum obtained by means of a production method according to one of the arrangements or one of the previous embodiments.

Of the possible applications of the invention, said part is a turbine blade, a portion of turbine nozzle, a portion of an outer or inner ferrule of a turbine, or a portion of the wall of a combustion chamber.

The present invention also relates to a turbine engine comprising a thermomechanical part according to one of the above embodiments.

Other advantages and characteristics of the invention will emerge from the following description given by way of example and in reference to the appended drawings which are schematic and aim in particular to illustrate the principles of the invention, in which:

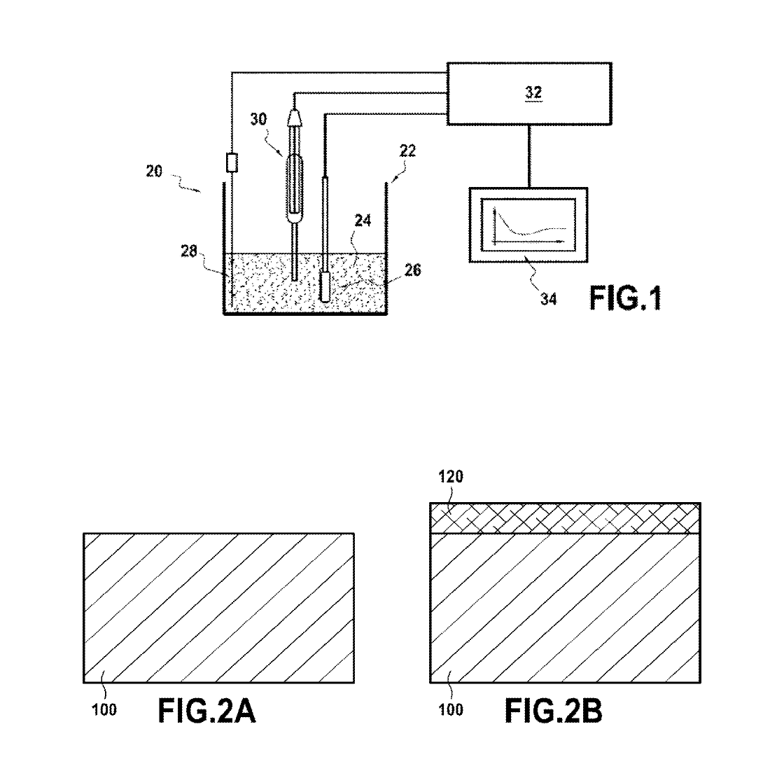

FIG. 1 is a partial view in projection which schematically shows an assembly which can be used for executing a production method of a metallic undercoat based on platinoid by the production method according to the invention,

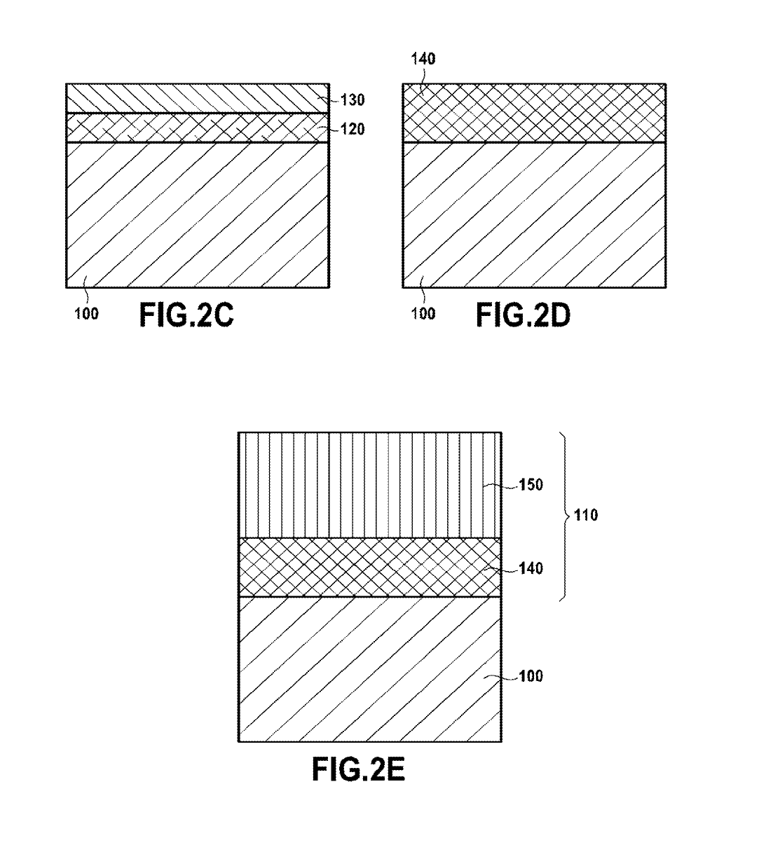

FIGS. 2A to 2E illustrate the principal steps of an example of a production method of a thermal barrier on a substrate and comprising a metallic undercoat, and a thermal protection ceramic-layer, and

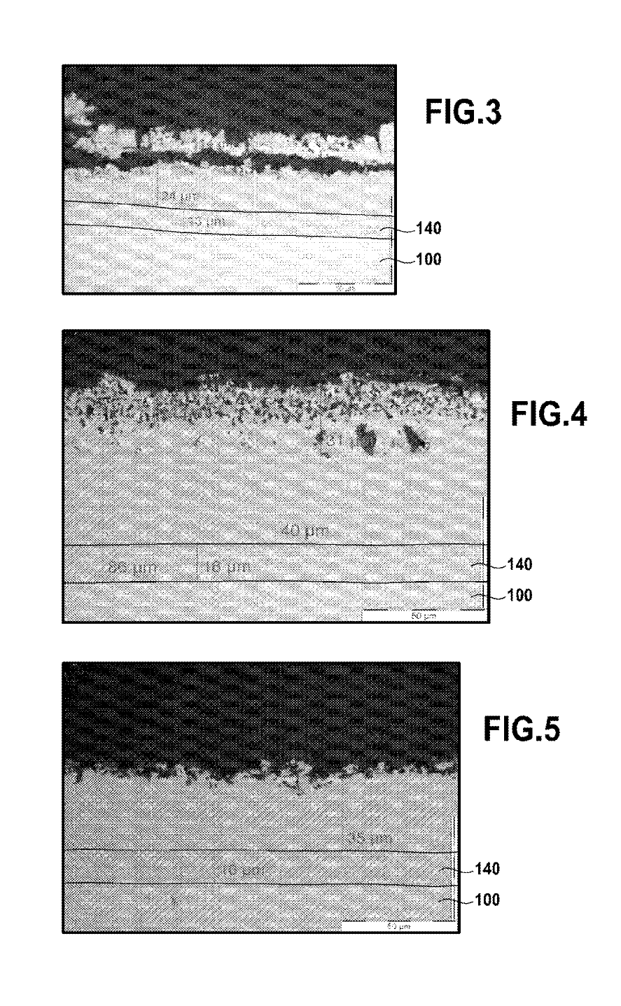

FIGS. 3 to 5 are micrographs of a substrate covered with a metallic undercoat obtained according to the method of the invention.

As is evident from FIG. 2A, this production process starts by providing a part made of superalloy forming a substrate 100 for manufacturing the thermal barrier 110: it is for example a turbine blade. The superalloy is especially a superalloy based on nickel.

This substrate 100 can be subject of chemical cleaning or other chemical or mechanical treatment intended to cleanse its surface. The substrate 100 preferably remains smooth and the roughness of its surface is not modified. Alternatively, sand-blasting or other type of attack is carried out to modify the roughness of the surface of the substrate 10.

A first embodiment is now described.

As shown in FIG. 2B, a platinum layer 120 or more generally a platinoid layer is deposited on the surface of the substrate 100, forming a coated substrate.

This platinum layer 120 has a thickness between 3 μm and 8 μm, preferably between 4 μm and 6 μm, and preferably of the order of 5 μm.

According to a preferred variant embodiment the platinum layer 120 is electrochemically deposited and in particular by electrolysis according to methods known per se.

According to another variant, the platinum layer 120 is deposited by solid deposition and in particular by chemical vapor deposition (CVD).

Next, as per the first embodiment of the invention deposition of an aluminium layer 130 on the coated substrate is carried out, above the platinum layer 120 by electrolysis in an ionic liquid medium.

The electroplating installation 20 used here comprises (see FIG. 1) a single tank 22 filled with electrolyte 24 in which the test piece or the part forming the substrate 100 to be coated is dipped and which serves as cathode 26 (work electrode). An anode 28 (or counter-electrode) is also immersed in the electrolyte 24. This anode 28 comprises chemically inert material relative to the electrolyte bath (electrolyte), for example in the form of a platinum grid, or an aluminium wire or any other material likely not to degrade the electrolyte solution during the electrochemical reaction.

Advantageously, the electroplating method also uses a reference electrode 30 which is placed near the cathode 26 to minimise the resistance effects of the electrolyte 24 and to allow better control during electroplating. This reference electrode 30 is constituted by a saturated calomel electrode SCE (mercury chloride Hg₂Cl₂), or preferably a glassy carbon electrode.

This electroplating installation 20 with three electrodes allows precise in-situ monitoring of the intensity and voltage simultaneously with deposition of the aluminium layer 130.

The three electrodes (cathode 26, anode 28 and reference electrode 30) are connected to a source of electric current 32 coupled to a control and data acquisition system 34.

Potentiostatic mode is preferably used, in which the source of electric current 32 imposes voltage (potential or voltage) between the anode 28 and the cathode 26. In this case, the source of electric current 32 is a potentiostat and the electroplating method is executed by application of voltage between the cathode 26 and the anode 28. The voltage applied between the cathode 26 and the anode 28 is preferably between −6V relative to the aluminium wire and +4.5 V (volts), preferably between −4.5 V and +4.5 V (volts),

The electrolyte or electrolyte bath contains the type(s) to be deposited on the cathode, in the form of salts dissolved in this electrolyte 24. Application of a density of current or electric potential enables reduction of types with which the layer of ceramic coating at the interface (diffusion layer) will be formed between the volume of electrolyte and the surface of the cathode 26 (substrate).

Homogeneous characteristics may be produced or as a gradient in the thickness of the deposition (composition, microstructure, crystallographic characteristics . . . ).

According to a preferred characteristic of the present invention an electrolyte with an ionic liquid solvent is used, which does not evaporate and does not create a detachment reaction of hydrogen near the cathode.

The electrolyte or electrolyte bath comprises a cation, an anion and an aluminium salt.

By way of cation, the following especially may be used:
quaternary ammonium salts such as tetraalkylammonium,
aromatic heterocycles such as imidazolium or pyridinium and in particular 1-ethyl-3-methylimidazolium (EMI),
saturated heterocycles such as piperidinium or pyrrolidinium and in particular 1-butyl-1-methylpyrrolidinium (BMP) or 1-propyl-1-methylpyrrolidinium (PMP), or
other cations such as sulfonium or phosphonium.

By way of anion, the following especially can be used:
halogenides such as Br—, Cl—, . . . and in particular chlorine Cl,
fluorated derivatives such as BF4-, PF6-, NTf2-, OTf-, . . .

and in particular bis(trifluoromethanesulfonyl)imide (NTF₂ or TFSI) or bis(fluorosulfonyl)imide (NF₂ or FSI),
sulphurous derivatives such as ROSO3-, RSO3-, or
cyanurated compounds such as (CN)3-, N(CN)2-, Ag(CN)2-.

Aluminium trichloride (AlCl₃) or aluminium Bis(trifluoromethanesulfonyl)imide (Al(III)NTf₂) especially may be used by way of aluminium salt.

First favourable assays were conducted with different baths 1 to 10 indicated in Table I.

TABLE I

IL (Ionic liquid)

| BATH | Anion | Cation | Salt |
|---|---|---|---|
| 1 | Cl | EMI | AlCl₃ |
| 2 | NTF₂ | BMP | AlCl₃ |
| 3 | NTF₂ | PMP | AlCl₃ |
| 4 | NF₂ | PMP | AlCl₃ |
| 5 | NTF₂ | EMI | AlCl₃ |
| 6 | NTF₂ | EMI | AlCl₃ |
| 7 | NF₂ | EMI | AlCl₃ |
| 8 | NTF₂ | EMI | Al(III)NTf₂ |
| 9 | NF₂ | EMI | Al(III)NTf₂ |
| 10 | NTF₂ | PMP | Al(III)NTf₂ |
| 11 | NF₂ | PMP | Al(III)NTf₂ |

Accordingly, with the bath 1, depositions were made with the following quantities of compounds: for 1 mole of ionic liquid (IL=Cl+EMI with identical molar quantities of Cl and EMI), 1.5 mole of metallic salt (AlCl₃).

This produces an aluminium layer 130 such as seen in FIG. 2C. Deposition by electrochemical method of the aluminium layer 130 ensures a solid bound (adhesion in high traction) with the platinum layer 120 located underneath.

Then the part undergoes diffusion heat treatment to enable formation of the metallic undercoat 140 (see FIG. 2D) of (Ni,Pt)AI type on the substrate 100, from the substrate 100 coated with the platinum layer 120 itself coated with the aluminium layer 130.

The diffusion treatment is preferably executed at a temperature of over 1000° C., preferably between 1000° C. and 1200° C., and preferably of the order of 1100° C.

Also, the diffusion treatment is preferably executed for a period of over an hour, preferably between 4 hours and 8 hours, and preferably of the order of 6 hours.

The first conclusive assays showed that:
for diffusion heat treatment executed after deposition of the first metallic layer and of the second metallic layer, highly satisfactory results are obtained with diffusion heat treatment at 1080° C. for 6 hours, and
for diffusion heat treatment executed after deposition of the first metallic layer and prior to deposition of the second metallic layer, highly satisfactory results are obtained with diffusion heat treatment at 1050° C. for 1 hour 30.

After the diffusion treatment, as seen in FIG. 2D, the platinum layer 120 and the aluminium layer 130 have interdiffused and with the substrate 100 and form a combined layer forming a metallic undercoat 140 of platinum modified nickel aluminide NiPtAl type.

Next, the thermal protection ceramic-layer 150 is deposited on the metallic undercoat 140 to form the thermal barrier 110.

Finally and optionally the part coated with the thermal barrier 110 can undergo finishing heat treatment in air to balance the stoechiometry of the thermal protection ceramic-layer 150.

The description preceding the first embodiment of the method for producing a metallic undercoat based on platinum on a metallic substrate according to the invention is modified as follows for the second, third and fourth embodiments.

For the second embodiment, a diffusion heat treatment step is interposed after deposition of the first metallic layer (platinum or platinoid layer 120) and prior to deposition of the second metallic layer which remains an aluminium layer 130.

For the third embodiment, the first metallic layer 120 and second metallic layer 130 are inverted relative to the metals of the first embodiment, specifically:
the first metallic layer 120 deposited on the substrate is an aluminium layer 130 electrolytically deposited in ionic medium, and
the second metallic layer 130 deposited on the first metallic layer 120 is a layer of a metal of the platinum group preferably electrolytically deposited. In the case of the third embodiment, as in the case of the first embodiment, a single diffusion heat treatment is performed after deposition of the two metallic layers (the first metallic layer and the second metallic layer).

As for the fourth embodiment, relative to the third embodiment it corresponds to the addition of an intermediate step of diffusion heat treatment after deposition of the first metallic layer, which is an aluminium layer 130 electrolytically deposited in ionic medium, and prior to deposition of the second metallic layer 130 which is a layer of a metal of the platinum group. The diffusion heat treatment is maintained however following deposition of the second metallic layer 130.

Reference is now made to FIGS. 3 to 5 corresponding to micrographic sections of a substrate 100 covered with a metallic undercoat obtained according to the method of the present invention.

In these samples, the substrate is made of “AM1”, specifically a superalloy which has the following composition, in weight percentages: 6 to 7% Co; 7 to 8% Cr; 1.8 to 2.2% Mo; 5 to 6% W; 7.5 to 8.5% Ta; 5.1 to 5.5% Al; 1 to 1.4% Ti; Hf, Fe each less than 0.2%; Nb, Mn, Si each less than 0.05%; C, Zr, B, Cu, P, S, Mg, Sn each less than 0.01%; Pb, Ag each less than 0.0005%; Bi less than 0.00005; the complement to 100% consisting of Ni, according to index H DMD0479-32 nomenclature.

FIG. 3 corresponds to the first embodiment, where the substrate 100 has been covered first by a platinum layer electrolytically deposited then an aluminium layer electrolytically deposited in ionic medium, and finally the result subjected to diffusion heat treatment of 1080° C. for 6 hours.

An interdiffused layer 140 of constant thickness of the order of 13 μm is clearly evident directly on the substrate 100, with a mottled appearance suggesting the two platinum and aluminium elements, and which is covered with an aluminium layer.

FIG. 4 corresponds to the second embodiment, where the substrate 100 has been covered first with a platinum layer electrolytically deposited, then undergoing diffusion heat treatment of 1050° C. for 1 hour 30, then the coated substrate has been covered with an aluminium layer electrolytically deposited in ionic medium, and finally the result has undergone diffusion heat treatment of 1080° C. for 6 hours

An interdiffused layer 140 of constant thickness of the order of 16 μm is clearly evident directly on the substrate 100, with a mottled appearance suggesting the two platinum and aluminium elements, and which is covered with an aluminium layer.

FIG. 5 corresponds to the third embodiment where the substrate 100 has been covered first with an aluminium layer electrolytically deposited in ionic medium, then in a platinum layer electrolytically deposited, and finally the result has undergone diffusion heat treatment of 1080° C. for 6 hours.

An interdiffused layer 140 of constant thickness of the order of 16 μm is clearly evident directly on the substrate 100, with an identical mottled appearance suggesting the two platinum and aluminium elements, and which is covered with an aluminium layer.

1. A method for producing a metallic undercoat based on platinoid on a metallic substrate, comprising:
a) providing a metallic part forming a substrate,
b) providing an electrolyte bath formed from an ionic liquid medium with one or more aluminium salts,
c) depositing a first layer of a first metal on the substrate so as to obtain a substrate coated with the first metallic layer,
d) depositing a second layer of a second metal on the first layer so as to obtain a substrate coated with the first metallic layer and the second metallic layer,
wherein one of the first metal and the second metal is a metal of the platinum group (platinoid),
the other from the first metal and the second metal is aluminium deposited by electroplating with said electrolyte bath formed from an ionic liquid medium,
and the aluminium layer has a thickness between 10 and 50 μm.

2. The method according to claim 1, wherein the method further comprises a diffusion heat treatment step of the coated substrate, said diffusion heat treatment step being applied on the coated substrate of the first metallic layer and/or on the coated substrate of the first metallic layer and of the second metallic layer.

3. The method according to claim 1, wherein said metallic substrate is made of superalloy.

4. The method according to claim 3, wherein said metallic substrate is made of superalloy based on nickel.

5. The method according to claim 1, wherein during the deposition step of the platinoid layer, the following sub-steps are conducted:
providing an ionic liquid medium or water-based electrolyte bath comprising a metal of the platinum group in solution, and
performing the electroplating of a layer of said metal of the platinum group with said electrolyte bath so as to obtain said coated substrate.

6. The method according to claim 1, wherein said ionic liquid medium forming said electrolyte bath comprises by way of cation one from 1-ethyl-3-methylimidazolium (EMI), 1-butyl-1-methylpyrrolidinium (BMP), and 1-propyl-1-methylpyrrolidinium (PMP), and by way of anion one from chlorine (Cl), bis(trifluoromethanesulfonyl)imide (NTF₂ or TFSI) and bis(fluorosulfonyl)imide (NF₂ or FSI).

7. The method according to claim 1, wherein said ionic liquid medium forming said electrolyte bath comprises aluminium trichloride (AlCl₃) and/or aluminium Bis(trifluoromethanesulfonyl)imide (Al(III)NTf₂) by way of aluminium salt.

8. A thermomechanical part with a metallic undercoat based on platinum obtained by a production method according to claim 1, wherein said part is a portion of an outer or inner ferrule of a turbine, or a portion of the wall of a combustion chamber.

9. A turbine engine comprising a thermomechanical part according to claim 8.
